(19) United States
(12) Patent Application Publication
(10) Pub. No.: US 2011/0282735 A1
(43) Pub. Date: Nov. 17, 2011

(54) Software Module And Method For Retrieval And Presentation Of Advertising Content

(76) Inventors: Tilen Kordis, Singer Island, FL (US); Jaka Jaksic, Singer Island, FL (US); Andrej Zeleznik, Dobrova (SI); Tom Logar, Singer Island, FL (US); Silvestra-Silvi Cepin, Singer Island, FL (US); Aleksander Cvetkovski, Singer Island, FL (US)

(21) Appl. No.: 13/087,455

(22) Filed: Apr. 15, 2011

Related U.S. Application Data
(60) Provisional application No. 61/334,845, filed on May 14, 2010.

(51) Int. Cl. G06Q 30/00; G06F 9/44

(52) U.S. Cl. 705/14.49; 717/121

(57) ABSTRACT

A software module which can be embedded into new or existing computer program. The module obtains advertising content from content providers and presents the content to a user on a computer during operation of the computer program. The content can be data, text, images, audio, video, 3D models, interactive content, or a combination thereof.

### RELATED APPLICATIONS

This application claims the benefit under 35 U.S.C. 119(e) of U.S. Provisional Patent Application No. 61/334,845, filed May 14, 2010, entitled SOFTWARE MODULE AND METHOD FOR RETRIEVAL AND PRESENTATION OF ADVERTISING CONTENT, the entirety of which is incorporated herein by reference.

### BACKGROUND OF THE INVENTION

Advertising in software is not a new concept, but existing ways of implementing advertising in software are costly, time consuming and provide relatively little benefit to software developers. Each software developer who wants to place advertisement into their software must implement their own solution for obtaining and displaying ads. This either requires a lot of resources, or results in a very primitive solution. The next challenge for software developers is to actually find advertising content to place into their software, and to get paid for the advertising, because no ready-made and publicly available system for software advertising exists. As a result, very few software products use advertising to support their development, even though many of them are being abandoned because of a lack of financing. By contrast, advertising on web sites is extremely popular, precisely because ready-made solutions for web advertising exist and are very easy to integrate.

There is a clear need for a ready-made advertising solution that software developers could easily integrate into their products.

### DEFINITIONS

Advertising: Directly or indirectly paid presentation of content.

Computer program: A program or application designed to run on a computer or other programmable device. Throughout this application the term refers to a program that can, will or does embed an embodiment of the invention.

Module: A self-contained software component or collection of components that can be integrated into a computer program.

Software developer: The person or company that has developed, owns, or has the means and rights to modify and distribute a computer program.

To prepare a computer program for distribution: To translate a program from source (development) form into executable form, e.g. by compiling or building, or by packaging source files into an executable and distributable form.

Content provider: A system of one or more servers containing and providing content.

User: Operator.

Weight: A numeric value representing a content's relative significance.

Size: Dimensions (width and height).

### BRIEF DESCRIPTION OF THE DRAWINGS

FIG. 1 is an illustration of the present invention in a computer program;

FIG. 2 is a flowchart illustrating the integration of the invention into computer program;

FIG. 3 is an illustration of the functionality of the present invention;

FIG. 4 is an example of the present invention incorporated into a computer program;

FIG. 5 is a flowchart of the present invention obtaining content from a content provider; and

FIG. 6 is an example of the present invention incorporated into a network including multiple content providers.

### DETAILED DESCRIPTION OF THE INVENTION

The invention is a software module that is embeddable into new or existing computer programs and implements the functionality of dynamically obtaining advertising content from content provider and presenting it to the end user.

An embodiment may include additional functionality, as well as support other non-advertising types of content. Different embodiments may include different functionality and support different types of content and presentation.

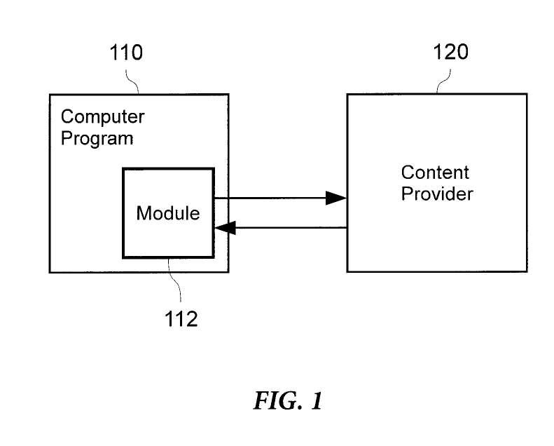

FIG. 1 illustrates an embodiment of the module 112 embedded within a computer program 110, and its communication with content provider 120.

The invention can be implemented using different technologies of implementation and integration (e.g. Microsoft .NET, COM, ActiveX, Delphi, C++, Adobe AIR, Flash, XUL, etc.), and it can be distributed in different forms: binary code, source code or technical specification to implement the required functionality (comprising description of the protocol of communication with the content provider, the data structures, and instructions for content presentation). Each embodiment can be embedded into computer programs that are technologically compatible with the embodiment. Functionality of different embodiments, as well as procedures of integration, may vary between different implementations.

The module is configurable by computer program developer during development or preparation of the computer program for distribution. By configuring the module, developer has an option to define one or more content display areas and their locations within the computer program, and to enter various configuration parameters, such as: computer program identifier, computer program developer identifier, content provider address, content presentation duration, minimum content presentation duration, maximum content presentation duration, visual styles of content display areas, one or more module behavior parameters, one or more parameters specifying whether said module or its display areas can be disabled, hidden, moved or resized. This enables the developer to adapt the module's appearance and behavior to best suit the computer program and its users, as well as identify the computer program and its developer to enable proper targeting and financial compensation.

Depending on the implementation and form of distribution, the configuration of the module can be performed in different ways (for example: by setting properties of an embeddable component, by writing or modifying source code, by writing or modifying one or more configuration files, by preparing procedure that sets system variables or registry entries during computer program installation). Some or all of the configuration parameters may also be preset in the module, bundled with the module or hard-coded into the module.

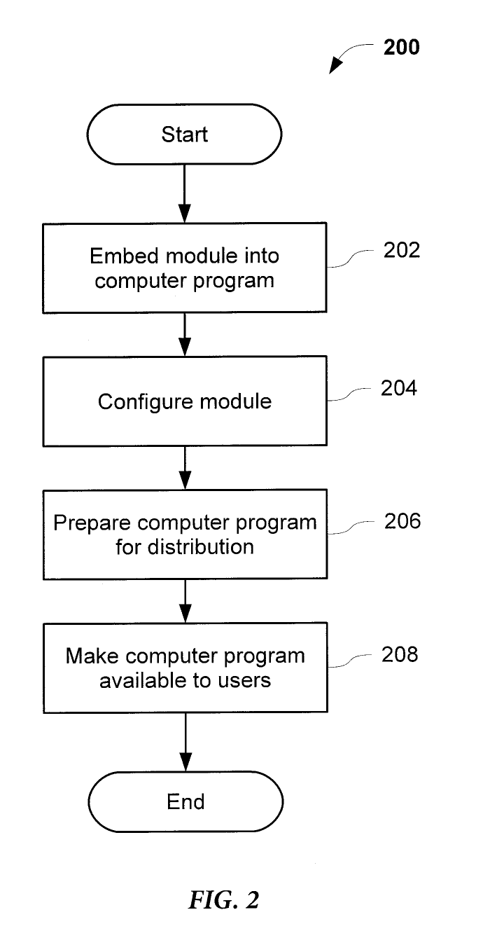

FIG. 2 illustrates a procedure performed by computer program developer to integrate the functionality of the invention into their computer program. Procedure 200 starts at step 202, which is the embedding of the module into the computer program. The actual embedding procedure depends on the technology and/or form of distribution. Most technologies provide an easy way to embed compatible third party libraries or source code. If no module implementation is compatible with the computer program, a compatible implementation can be created from a technical specification. The next step is 204, which is to configure the embedded module, the actual process again depending on the embodiment. The next step is 206, which is to prepare the computer program for distribution. The last step is 208, which is to distribute the computer program or make it available to the end users. The integration procedure can be performed at any stage of computer program development.

The module may allow users of the computer program to enter their demographic data and/or content preferences, which may be used by content provider for targeting and to provide users more appealing contents. It may also allow users to set their network connection preferences, such as connection speed and/or the cost of data transfer (so that, for example, large contents are only obtained over fast and cheap connections).

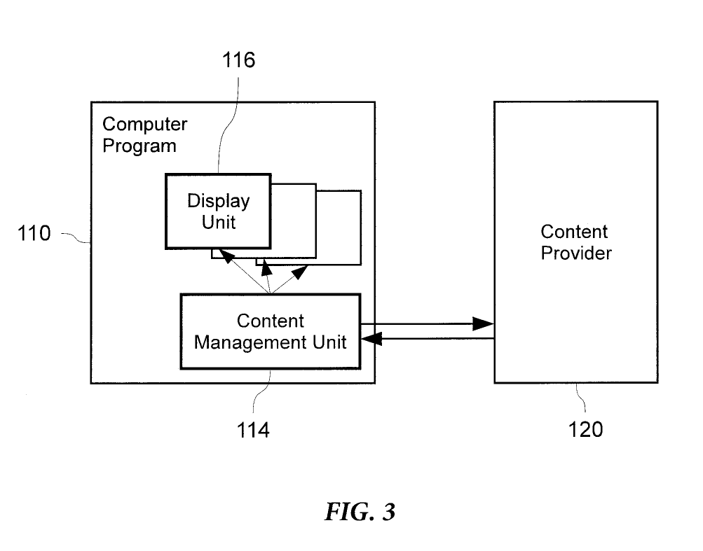

FIG. 3 illustrates a logical structure of the module's functionality. As depicted, the module's functionality is logically divided between content management unit 114 and display unit 116. Content management unit contains the functionality of obtaining and managing contents, while display unit contains the functionality of displaying contents in one display area. It is intended that each computer program contains a single content management unit and zero or more display units. Each display unit can have different dimensions, position, priority and configuration, and may display only one or multiple contents simultaneously. The actual architecture of the module depends on implementation and form of distribution.

Each content display area can be of permanent or temporary nature, where permanent means that they exist during the entire computer program operation, while temporary means that they only appear on certain occasions, such as: when the computer program is being started or terminated; certain actions initiated by user within the computer program (e.g. moving a mouse over an element or opening a form); being triggered by content (for example, a content may trigger the presentation of related content when mouse is moved over it); fixed or random time intervals, or being programmatically triggered by the computer program.

Temporary display areas may be created either by the computer program developer or automatically by the module's functionality.

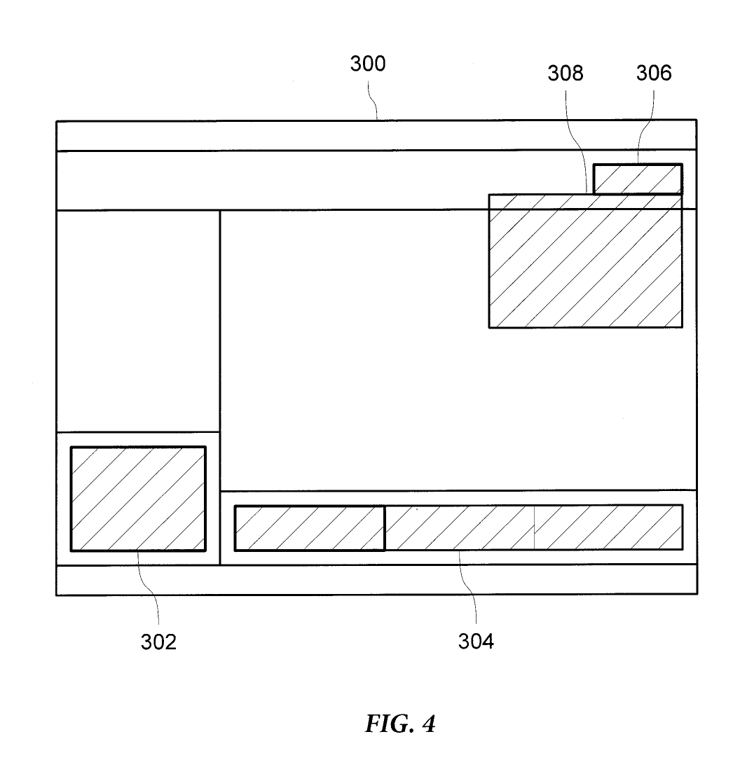

FIG. 4 illustrates an example computer program with integrated module. The example shows a computer program 300 using three differently placed display units: 302, 304 and 306, where display units 302 and 306 can simultaneously display only one content, while 304 can display multiple contents. 308 is an example of a temporary display area showing content related to 306. The temporary display area 308 is not always present during operation of the computer program. The size and shape of display areas 302, 304, 306 and temporary display area 308 can be changed depending on the needs of the computer program developer and/or computer program. For example, the display areas 302, 304, 306 and 308 can be rectangular, as shown, or circular or oval or any other shape. They can also occupy a relative small or large portion of the screen. The actual number, types and placement of display units is defined by the developer of the computer program.

The module normally obtains content by sending a request (such as TCP) to a content provider via a network (such as the internet). The actual choice of communication infrastructure and protocols depends on implementation.

The module may obtain content on one or more of the following events: when the computer program is started; fixed or random time intervals; when new content is needed (e.g. when all of the content has been used); when a display area becomes visible; certain actions initiated by user within the computer program (e.g. clicking a button or opening a form); or being programmatically triggered by the computer program.

An alternative way of obtaining content (which an implementation of the module may or may not support) is to bundle some contents and distribute them together with the computer program, so that the module may use them without the need for network connection.

A request may contain one or more parameters that identify the computer program and its developer, and define various characteristics of the computer program, the operating system, the computer, the user or usage, to help the content provider select the most appropriate (targeted) contents. Such parameters may include: network address of computer, module platform, module version, supported content types, computer program identifier, computer program developer identifier, computer program version, computer program checksum, computer program category, user interface language, display window size, operating system type, operating system version, operating system language, computer type, screen size, number and sizes of content display areas, number of requested contents, computer program usage statistics, content display statistics, statistics of user's interaction with content, user's preferences, user's demographic data, geographic location, country, connection type, connection speed, or other information.

Based on the request, the content provider prepares a response and sends it back to the requesting module. The response may contain, but is not limited to: parameters for configuration of module behavior, one or more contents and/or meta-data that further defines the content's properties.

Parameters for configuration of module behavior may include, but are not limited to: one or more content provider addresses, content display interval, minimum content display interval, maximum content display interval, visual styles of content display areas, permissions to disable, hide, move or resize content display areas.

There can be different forms of content, such as: structured data, text, image, moving image, audio, video, animation, rich text, three dimensional objects, HTML, website, interactive content (such as Flash), or a combination thereof. The response may also contain references (like identifiers or full or partial URLs) to other contents or pieces of content that the module can obtain through subsequent requests, from either the same or different server or content provider.

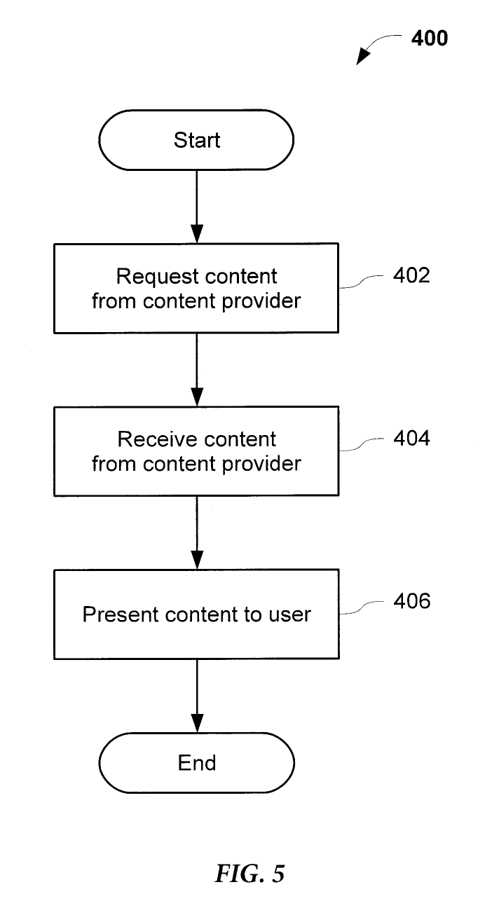

FIG. 5 illustrates an embodiment of the basic process of obtaining content 400. A request is sent to the content provider by the module 112 of the present invention at 402. The module 112 receives the content requested from the content provider at 404. The content is then presented to the user or consumer at 406. The module normally obtains content by sending a request (such as TCP) to a content provider via a network (such as the internet). The actual choice of communication infrastructure and protocols depends on implementation.

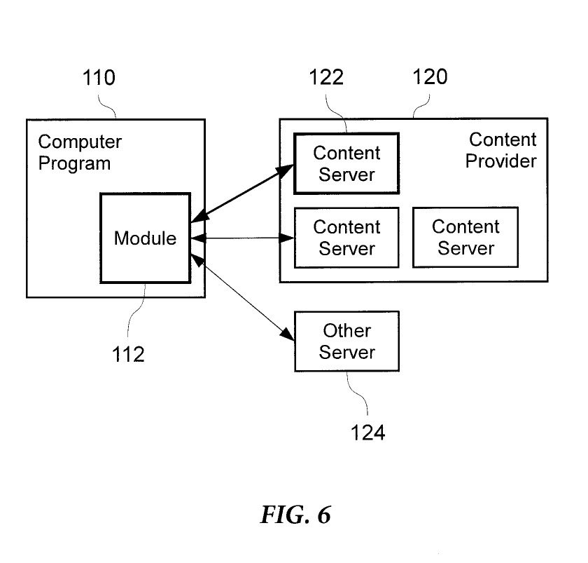

FIG. 6 illustrates an example embodiment of a network environment containing a content provider 120 with multiple content servers 122, and an unrelated third party server 124. The module of the present invention 112 can request and obtain content from a content provider 120, a third party server 124, or both. Actual network embodiments can vary.

The following are some examples of how the communication might be structured:
The initial response contains structured data (such as XML or JSON), which contains: module configuration parameters, meta-data of one or more contents, any simple (textual) contents, and references to complex (non-textual) resources. Any referenced resources (such as images or video) are retrieved through subsequent requests.
The response is a bundle (such as a TAR or ZIP file) that contains one or more structured data files defining contents, as well as related resources.
Each response contains only one piece of content. Module configuration is obtained optionally, through separate requests.

Embodiments of the invention may implement any one of these or a different method of obtaining content from content provider. Different embodiments may implement different methods of communication. However, different embodiments may implement the same method or methods that are compatible with a particular content provider, in order to be able to use the same content provider as other embodiments.

Once content is obtained, it may be stored by the module in a local cache, and used or reused later. This enables the module to retrieve a larger number of contents at once and thus reduce the number of requests, which reduces network and server load.

The main purpose of the invention is to enable distribution of advertising contents. However, embodiments may also implement support for other kinds of content, such as notifications, advice, news, polls, jokes, games, feedback requests, etc., to make the experience more interesting and beneficial to the end users.

Meta-data related to a content may define one or more of the following content properties: content type, weight, priority, presentation time intervals, period of validity, specification of one or more forms of presentation, duration of presentation, minimum duration of presentation, maximum duration of presentation, times of day of presentation, days of the week of presentation, content size (dimensions), minimum size, maximum size, consequences of user interaction, content length in bytes.

Content properties can influence content ordering, positioning, and presentation in various ways, especially when there are multiple contents queued up for presentation. These are some examples of how the module might order and position contents based on their properties:
Contents are ordered based on their weight or priority and are presented in that order. If there are multiple display areas, display areas with higher priorities are used before display areas with lower priorities.
Contents are selected and displayed randomly, where the probability of each content being selected is proportional to its weight.
Contents are presented in no particular order, but the duration of presentation of each content is proportional to its weight.
Contents are distributed among display areas based on types and dimension requirements of various contents. Each content is only distributed to those display areas where they fit and where the content type is supported and enabled.

Embodiments of the invention may implement any of these or any different methods of content ordering and positioning.

Embodiments of the invention may facilitate various levels and forms of interaction with the content, such as: moving an indicator (such as a mouse or a trackball) over a displayed content, clicking on a displayed content, clicking on a particular area of a displayed content, manipulating (e.g. scrolling or zooming) a content, starting, stopping, pausing or resuming a content (if content is a video clip), bookmarking a content, closing, hiding or skipping a content, indicating that the user likes or dislikes a content, rating a content, selecting one or more choices in a poll, typing in feedback to a content, or engaging in interaction with an interactive content (e.g. playing a game).

Interaction with content can trigger one or more of the following: opening a web browser with an associated web site; opening an associated web site in an embedded browser; presenting associated content within the same or different display area; retrieving new content; saving a record of said interaction; updating statistical data; or sending statistics or a notification of the interaction to content provider; calling an external program (e.g. an email program, a telephony or voice call program) to perform some function and/or receive feedback from said external program; making a post to a social network; or other operation.

The module may collect and/or store statistics of computer program usage (such as times and durations of usage) and user's interactions with content, and send them to content provider. Statistics can be sent to content provider as part of content requests, as separate requests, periodically or when interaction occurs.

The module may include the functionality of logging certain user interactions (such as clicks) and allowing users to later review the history of their interactions and revisit the contents that they found interesting.

The module may include a programmable interface (an API) to provide computer program developers greater control over the module's function and behavior. Such interface might enable the computer program to: hide, show, enable, disable, resize, move or set configuration parameters of module or individual display areas; implement its own custom methods of content management, ordering, positioning and/or presentation; or be notified of the module's events (such as communication events or errors, content management or presentation events, and user interaction events) and given a chance to handle them, whereby the computer program may change its content or behavior.

What is claimed is:

1. A computer software product for use with a computer, said computer software product comprising:
a module constructed and arranged to be embedded into a computer program;
said module is operable upon running of said computer program, said module is operable to send a content request to a content provider;
said module receiving from said content provider at least one advertising content corresponding to said content request; and
at least one configuration parameter of said module is established prior to said computer program being prepared for distribution.

2. The computer software product of claim 1, wherein said module is embodied as binary code.

3. The computer software product of claim 1, wherein said module is embodied as source code.

4. The computer software product of claim 1, wherein said computer program has at least one display area, each said display area displaying said content from said content provider.

5. The computer software product of claim 4, wherein said at least one display area is continuously visible during the operation of said computer program.

6. The computer software product of claim 4, wherein said at least one display area is visible only under certain conditions during the operation of said computer program.

7. The computer software product of claim 4, wherein said module includes a central unit constructed and arranged for content management and communication; and
at least one content display unit, said content display unit providing a display area.

8. The computer software product of claim 1, wherein each said configuration parameter comprises at least one of the following: an identifier of said computer program, computer program developer identifier, content provider address, content presentation duration, minimum content presentation duration, maximum content presentation duration, visual styles of content display areas, at least one module behavior parameter, and at least one permission specifying whether said module or its display area can be disabled, hidden, moved or resized.

9. The computer software product of claim 1, wherein said content request is sent to said content provider upon the occurrence of one of the following conditions: when the computer program is started, random time intervals, fixed time intervals, when new content is required, when a display area becomes visible, when an operator initiates an action in the computer program, and when said computer program has triggered said request.

10. The computer software product of claim 1, wherein said advertising content is obtained from a plurality of content providers.

11. The computer software product of claim 1, wherein said content request contains at least one parameter.

12. The computer software product of claim 11, wherein said parameter comprises at least one of the following: a network address of said computer, a module platform, a version of said module, a list of content types that said module supports, an identifier of said computer program, an identifier of said computer program developer, a version of said computer program, a category of said computer program, a checksum of said computer program, a user interface language, dimensions of a display window, a type of operating system of said computer, type of said computer, screen size of said computer, number of requested contents, computer program usage data, content display data, data regarding an operator's interaction with said content, an operator's preference, an operator's demographic data, a location of said computer, number and dimensions of content display areas, version of operating system of said computer, language of the operating system, network connection type of said computer, and network connection speed of said computer.

13. The computer software product of claim 1, wherein a network connection between said computer and said content provider remains open allowing said advertising content to be pushed to said module from said content provider.

14. The computer software product of claim 1, wherein said module additionally receives from said content provider at least one of the following: advertisement, notification, advice, news, polls, jokes, games and feedback requests.

15. The computer software product of claim 1, wherein said advertising content is in at least one of the following forms: structured data, text, image, moving image, audio, video, animation, three dimensional objects, rich text, HTML, web site and interactive content.

16. The computer software product of claim 1, wherein an operator of said computer interacts with said advertising content received from said content provider.

17. The computer software product of claim 16, wherein said interaction includes at least one of the following: moving an indicator over said display content, clicking on said display content, clicking on a particular area of said display content, manipulating said display content, starting said content, stopping said content, pausing said content, resuming said content, bookmarking said content, rating said content, supplying feedback to a content, interaction with an interactive content, closing said content, hiding said content, skipping said content and selecting a choice in a poll.

18. A computer software product of claim 16, wherein said interaction with said content initiates one of the following actions: opening a web browser with an associated web site, opening an associated web site in an embedded browser, presenting associated content within said display area or different display area, retrieving new content, saving a record of said interaction, updating data relating to at least one internal statistic, sending a notification of said interaction to said content provider, calling an external program, or making a post to a social network.

19. The computer software product of claim 1, wherein said advertising content includes meta-data which further defines properties of said advertising content.

20. The computer software product of claim 19, wherein said meta-data defines at least one of the following content properties: content type, content weight, content priority, at least one presentation time interval, period of validity, specification of at least one form of presentation, duration of presentation, minimum duration of presentation, maximum duration of presentation, content dimensions, minimum content dimensions, maximum content dimensions, consequences of interaction with said content by an operator of said computer, content length in bytes, time of day of presentation and day of the week of presentation.

21. The computer software product of claim 20, wherein priority of said advertising content defines at least one of the following: order of presentation of said content, probability of presentation of said content, duration of presentation of said content, frequency of presentation of said content, and position of presentation of said content.

22. The computer software product of claim 1, wherein said module receives from said content provider at least one parameter which determines the operation of said module.

23. The computer software product of claim 22, wherein said at least one parameter comprises at least one of the following: content provider address, content display interval, minimum content display interval, maximum content display interval, visual style of a content display area, permission to disable, hide, move or resize a display area.

24. The computer software product of claim 1, wherein there are multiple content requests.

25. The computer software product of claim 1, wherein there are multiple content providers.

26. The computer software product of claim 1, wherein said advertising content contains at least one reference to related content received subsequent to an initial content request.

27. The computer software product of claim 1, wherein said advertising content is stored on said computer and reused at a later time.

28. The computer software product of claim 1, wherein said computer program includes at least one content.

29. The computer software product of claim 1, wherein said module contains at least one content.

30. The computer software product of claim 1, wherein said module sends data of at least one of the following: computer program usage, content presentation, and operator interaction with said content.

31. The computer software product of claim 30, wherein said data relating to said computer program usage, content presentation and operator interaction with said content is sent to said content provider as part of said content request.

32. The computer software product of claim 30, wherein said data relating to said computer program usage, content presentation and operator interaction with said content is sent to said content provider as a separate request from said content request.

33. The computer software product of claim 1, wherein said module provides a programmatic interface to said computer program.

34. The computer software product of claim 33, wherein said computer program product can hide, show, enable, disable, resize, move a display area, and set configuration parameters of a display area.

35. The computer software product of claim 33, wherein said programmatic interface enables said computer program developer to implement at least one specific mechanism for displaying said content.

36. The computer software product of claim 33, wherein said programmatic interface enables said computer program to handle or react to events occurring within said module.
